(19) United States
(12) Patent Application Publication
(10) Pub. No.: US 2021/0067622 A1
(43) Pub. Date: Mar. 4, 2021

(54) USER TERMINAL APPARATUS AND CONTROL METHOD FOR CONTROLLING SAME

(71) Applicant: Samsung Electronics Co., Ltd., Suwon-si, Gyeonggi-do (KR)

(72) Inventors: Hyungryoung PARK, Suwon-si (KR); Jeahwan GO, Suwon-si (KR)

(21) Appl. No.: 16/961,785

(22) PCT Filed: Jan. 2, 2019
(86) PCT No.: PCT/KR2019/000032

§ 371 Date: Jul. 13, 2020

(30) Foreign Application Priority Data
Feb. 2, 2018 (KR) 10-2018-0013503

(51) Int. Cl. H04M 1/725; H04L 12/28; G06F 3/0482

(52) U.S. Cl. CPC H04M 1/72533; G06F 3/0482; H04L 12/2816

(57) ABSTRACT

Disclosed is a user terminal apparatus in which a first home appliance and a second home appliance are registered. A user terminal apparatus comprises: a communication unit; a display; and a processor for providing, on a display, a first item and a second item for controlling a first home appliance and a second home appliance, respectively, changing a display state of the second item when state information, in which the first home appliance is configured as a master device and the second home appliance is configured as a slave device, is received through the communication unit, and providing a UI for integrally controlling the first home appliance and the second home appliance, on the display when the first item is selected.

### BACKGROUND ART

### Technical Field

The disclosure relates to a user terminal apparatus and a control method for the same, and more particularly, to a user terminal apparatus that controls home appliances interlocked with one another, and a control method for the same.

### Description of the Related Art

In the past, in the case of an apparatus used by interlocking a plurality of apparatuses with one another, even when the apparatuses were interlocked, the individual apparatuses had to be separately controlled on a smartphone screen.

That is, in case a plurality of apparatuses were interlocked with one another, the plurality of interlocked apparatuses had to be controlled by a single apparatus, but on a smartphone, the apparatuses were recognized as individual apparatuses and screens for controlling the individual apparatuses were respectively constituted, and thus there was inconvenience for a user of having to input a user instruction separately into each apparatus.

### DETAILED DESCRIPTION OF THE INVENTION

### Technical Problem

The disclosure was devised according to the aforementioned need, and the purpose of the disclosure is in providing a user terminal apparatus that integrally controls interlocked home appliances, and a control method for the same.

### Technical Solution

A user terminal apparatus in which a first home appliance and a second home appliance are registered according to an embodiment of the disclosure for achieving the aforementioned purpose may include a communicator, a display, and a processor configured to provide a first item and a second item for controlling the first home appliance and the second home appliance respectively on the display, and change a display state of the second item based on state information in which the first home appliance is configured as a master device and the second home appliance is configured as a slave device being received through the communicator, and provide a UI for integrally controlling the first home appliance and the second home appliance on the display based on the first item being selected.

The processor may, based on receiving the state information, change the second item into an inactivated state.

A UI for integrally controlling the first and second home appliances may include a menu for controlling the first home appliance.

The processor may, based on the menu being selected, transmit a control command for making a control operation corresponding to the menu performed at both of the first and second home appliances to the first home appliance.

The processor may, based on the first and second home appliances being home appliances of different types, and a function corresponding to the menu being a common function of the first and second home appliances, transmit a first control code and a second control code respectively corresponding to the types of the first and second home appliances to the first home appliance.

The processor may, based on the first and second home appliances being home appliances of different types, and a function corresponding to the menu not being a function provided at the second home appliance, transmit a control code for controlling such that the second home appliance provides a function related to the function corresponding to the menu to the first home appliance.

The state information may be received from at least one of the first or second home appliances, or received from an external server.

The first home appliance may be configured as a master device based on at least one of an arrangement state of the first and second home appliances or a user instruction.

The processor may, based on the second item being selected, provide information notifying that the second home appliance is integrally controlled on a UI for controlling the master device.

The processor may, based on receiving the state information, provide information indicating whether the first and second home appliances are a master device or a slave device through the display.

A system comprising a first home appliance and a second home appliance and a user terminal apparatus capable of integrally controlling the home appliances according to an embodiment of the disclosure may include a first home appliance and a second home appliance transmitting state information in which the first home appliance is configured as a master device and the second home appliance is configured as a slave device to the user terminal apparatus, and a user terminal apparatus configured to provide a first item and a second item for controlling the first home appliance and the second home appliance respectively, and change a display state of the second item based on receiving the state information, and provide a UI for integrally controlling the first home appliance and the second home appliance based on the second item being selected.

A control method of a user terminal apparatus in which a first home appliance and a second home appliance are registered according to an embodiment of the disclosure may include the steps of providing a first item and a second item for controlling the first home appliance and the second home appliance respectively, changing a display state of the second item based on state information in which the first home appliance is configured as a master device and the second home appliance is configured as a slave device being received, and providing a UI for integrally controlling the first home appliance and the second home appliance based on the first item being selected.

In the step of changing a display state, based on receiving the state information, the second item may be changed into an inactivated state.

A UI for integrally controlling the first and second home appliances may include a menu for controlling the first home appliance.

The control method may further include the step of, based on the menu being selected, transmitting a control command for making a control operation corresponding to the menu performed at both of the first and second home appliances to the first home appliance.

In the step of transmitting, based on the first and second home appliances being home appliances of different types, and a function corresponding to the menu being a common function of the first and second home appliances, a first control code and a second control code respectively corresponding to the types of the first and second home appliances may be transmitted to the first home appliance.

Also, in the step of transmitting, based on the first and second home appliances being home appliances of different types, and a function corresponding to the menu not being a function provided at the second home appliance, a control code for controlling such that the second home appliance provides a function related to the function corresponding to the menu may be transmitted to the first home appliance.

The state information may be received from at least one of the first or second home appliances, or received from an external server.

The control method may further include the step wherein the first home appliance is configured as a master device based on at least one of an arrangement state of the first and second home appliances or a user instruction.

Also, the control method may further include the step of, based on the second item being selected, providing information notifying that the second home appliance is integrally controlled on a UI for controlling the master device.

In addition, the control method may further include the step of, based on receiving the state information, providing information indicating whether the first and second home appliances are a master device or a slave device.

### Effect of the Invention

According to the various embodiments of the disclosure as described above, a plurality of interlocked home appliances can be integrally controlled like one apparatus, and thus user convenience is improved.

### BRIEF DESCRIPTION OF DRAWINGS

FIG. 1 is a schematic diagram for illustrating an electronic system wherein interlocked home appliances are controlled by a user terminal apparatus according to an embodiment of the disclosure;

FIG. 2 is a block diagram illustrating a configuration of a home appliance according to an embodiment of the disclosure;

FIG. 3 is a diagram for illustrating a UI controlling first and second home appliances of the same type according to an embodiment of the disclosure;

FIG. 4 is a diagram for illustrating a UI controlling first and second home appliances of different types according to an embodiment of the disclosure;

FIG. 5 is a diagram for illustrating a UI controlling first and second home appliances that are not laminated according to an embodiment of the disclosure;

FIG. 6 is a sequence diagram for illustrating operations among a user terminal apparatus, a server, and first and second home appliances according to an embodiment of the disclosure;

FIG. 7 is a diagram for illustrating an operation of indicating that first and second home appliances are in an interlocked state on a display according to an embodiment of the disclosure;

FIG. 8 is a diagram illustrating an example of a detailed configuration of the user terminal apparatus in FIG. 2; and

FIG. 9 is a flow chart for illustrating a control method of a user terminal apparatus according to an embodiment of the disclosure.

### BEST MODE FOR IMPLEMENTING THE INVENTION

### MODE FOR IMPLEMENTING THE INVENTION

Hereinafter, the disclosure will be described in detail with reference to the drawings. In describing the disclosure, in case it is determined that detailed explanation of related known functions or components may unnecessarily confuse the gist of the disclosure, the detailed explanation will be omitted. In addition, the embodiments below may be modified in various different forms, and the scope of the technical idea of the disclosure is not limited to the embodiments below. Rather, these embodiments are provided to make the disclosure more sufficient and complete, and to fully convey the technical idea of the disclosure to those skilled in the art.

Also, the description that a part ‘includes’ an element means that another element may be further included, but not that another element is excluded, unless there is a particular opposing description. Further, various elements and areas in drawings were illustrated schematically. Accordingly, the technical idea of the disclosure is not limited by the relative sizes or intervals illustrated in the accompanying drawings.

In addition, the expression ‘at least one of a, b, or c’ may be interpreted as ‘a,’ ‘b’, ‘c,’ ‘a and b,’ ‘a and c,’ ‘b and c,’ or ‘a, b, and c.’

Hereinafter, the disclosure will be described in detail with reference to the accompanying drawings.

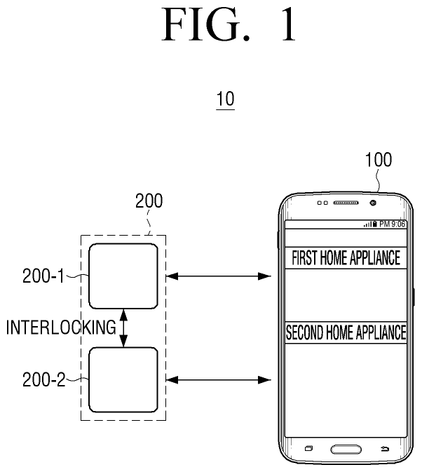

FIG. 1 is a schematic diagram for illustrating an electronic system wherein interlocked home appliances are controlled by a user terminal apparatus according to an embodiment of the disclosure.

According to FIG. 1, the electronic system 10 includes a user terminal apparatus 100, and first and second home appliances 200.

The user terminal apparatus 100 performs communication with the first and second home appliances 200 directly or performs communication with the first and second home appliances 200 through a server (not shown). That is, if a user instruction is input, the user terminal apparatus 100 may directly transmit the input instruction to the first and second home appliances 200 or transmit the input instruction to the first and second home appliances 200 through a server. Here, a server may be a cloud server wherein information on the first and second home appliances 200 is stored.

The user terminal apparatus 100 may be implemented as a mobile phone like a smartphone that is capable of communicating with the first and second home appliances 200 or the server, but is not limited thereto, and it may be implemented as a tablet, a laptop computer, a PC, a remote control, etc.

Each of the first and second home appliances 200 may be a module type apparatus that can be detached from or attached to each other, and is interlocked with each other in case it is attached. Each home appliance 200-1, 200-2 may independently perform the functions of a home appliance, and in case the first and second home appliances 200 are interlocked, they may integrally perform the functions of a home appliance like one apparatus. That is, in case the first and second home appliances 200 are interlocked and integrally controlled, if a user instruction is input, the interlocked first and second home appliances 200 may perform an operation corresponding to the user instruction together.

Here, interlocking may not only be a state wherein the first and second home appliances 200-1, 200-2 physically contact each other and are communicatively connected or are arranged to be adjacent to each other and are communicatively connected but also a state wherein the first and second home appliances 200-1, 200-2 are communicatively connected with each other even though they are not arranged to be adjacent and are integrally controlled from the user terminal apparatus 100.

The first and second home appliances 200-1, 200-2 are module type apparatuses and may be implemented as an air purifier, a humidifier, a speaker, etc. However, the first and second home appliances 200-1, 200-2 are not limited thereto as long as they are apparatuses that are communicatively connected with each other and are integrally controlled, even though they cannot be detached from or attached to each other. For example, the first and second home appliances 200-1, 200-2 may be implemented as home appliances in various forms such as an air conditioner, a robot cleaner, etc.

As an example, if the second home appliance 200-2 which is an air purifier is arranged on the top portion of the first home appliance 200-1 which is an air purifier and is interlocked with the first home appliance 200-1, the first and second home appliances 200-1, 200-2 may be integrally controlled. Alternatively, if the first home appliance 200-1 which is a stand type air conditioner located in a living room and the second home appliance 200-2 which is a wall mounted air conditioner located in a room are interlocked, the first and second home appliances 200-1, 200-2 may be integrally controlled.

According to an embodiment of the disclosure, in case the first and second home appliances 200 are interlocked, one of the first and second home appliances 200 may be a master device and the other may be a slave device controlled by the master device, and the first and second home appliances 200 may be integrally controlled. The user terminal apparatus 100 just needs to control the master device for integrally controlling the first and second home appliances 200. Hereinafter, various embodiments of the disclosure will be described in detail with reference to the drawings.

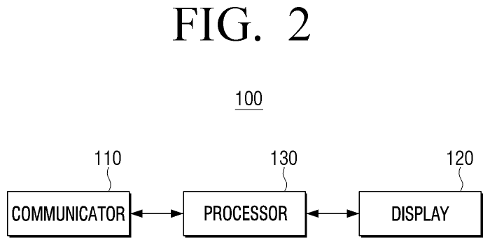

FIG. 2 is a block diagram illustrating a configuration of a home appliance according to an embodiment of the disclosure.

According to FIG. 2, the user terminal apparatus 100 includes a communicator 110, a display 120, and a processor 130.

The communicator 110 performs communication with the first and second home appliances 200. Alternatively, the communicator 110 may perform communication with an external server (not shown).

Here, the communicator 110 may perform wireless communication with the first and second home appliances 200 or an external server by communication methods such as BlueTooth (BT), Wireless Fidelity (WI-FI), Zigbee, Infrared (IR), etc. Also, the communicator 110 may perform communication with the first and second home appliances 200 or an external server through various communication methods such as Serial Interface, Universal Serial Bus (USB), Near Field Communication (NFC), etc.

For example, if a predetermined event occurs, the communicator 110 may perform communication with the first and second home appliances 200 according to a predetermined communication method, and become a connected state. Here, connection may mean all states wherein communication becomes possible such as an operation that communication is initialized between the user terminal apparatus 100 and the first and second home appliances 200, an operation that a network is formed, an operation that device paring is performed, etc. For example, identification information of each of the first and second home appliances 200 may be provided to the user terminal apparatus 100, and in accordance thereto, a paring procedure between the two apparatuses may be performed. For example, if a predetermined event occurs at the user terminal apparatus 100 or the first and second home appliances 200, an adjacent apparatus is searched through a Digital Living Network Alliance (DLNA) technology and paring with the searched apparatus is performed, and the apparatuses may become a connected state.

Here, identification information may include the IP addresses, MAC addresses, product names, and product numbers of each of the first and second home appliances 200, and type information indicating the types of each of the first and second home appliances 200, etc.

The display 120 may provide an item for controlling the first and second home appliances 200 according to control of the processor 130. Also, if an item for controlling the master device between the first and second home appliances 200 is selected, the display 120 may provide a UI for integrally controlling the first and second home appliances 200 according to control of the processor 130.

Here, an item may be an icon displayed to display a UI for controlling each of the first home appliance 200-1 and the second home appliance 200-2. For example, if a first item corresponding to the first home appliance 200-1 is selected, a UI for controlling the first home appliance 200-1 is displayed, and if a second item corresponding to the second home appliance 200-2 is selected, a UI for controlling the second home appliance 200-2 may be displayed.

The display 120 may be implemented as various forms such as a liquid crystal display (LCD), organic light-emitting diodes (OLEDs), Liquid Crystal on Silicon (LCoS), Digital Light Processing (DLP), a quantum dot (QD) display panel, etc.

The processor 130 controls the overall operations of the user terminal apparatus 100.

According to an embodiment of the disclosure, the processor 130 may be implemented as a digital signal processor (DSP) processing digital signals, a microprocessor, and a time controller (TCON). However, the disclosure is not limited thereto, and the processor 130 may include one or more of a central processing unit (CPU), a micro controller unit (MCU), a micro processing unit (MPU), a controller, an application processor (AP) or a communication processor (CP), and an ARM processor, or may be defined by the terms. Also, the processor 130 may be implemented as a System on Chip (SoC) having a processing algorithm stored therein or large scale integration (LSI), or in the form of a field programmable gate array (FPGA).

When the user terminal apparatus 100 is communicatively connected with the first and second home appliances 200, the processor 130 may recognize the first and second home appliances 200 as controllable apparatuses and register them in the user terminal apparatus 100. According to an embodiment of the disclosure, the processor 130 may store identification information of the first and second home appliances 200 in a storage part (not shown), and when a user instruction for controlling at least one of the first and second home appliances 200 is input, the processor 130 may transmit a control signal for controlling at least one of the first and second home appliances 200 to at least one of the first and second home appliances 200 based on the stored identification information. Meanwhile, in case the first and second home appliances 200 are in a state of being interlocked with each other, a signal corresponding to the user instruction may be transmitted only to the master device between the first and second home appliances 200. Hereinafter, an operation for the user terminal apparatus 100 to integrally control the first and second home appliances 200 in case the first and second home appliances 200 are in an interlocked state will be described in detail.

The processor 130 may provide first and second items for respectively controlling the first and second home appliances 200 on the display 120.

Here, the first and second items may be icons displayed to display a UI for respectively controlling the first home appliance 200-1 and the second home appliance 200-2. For example, if the first item corresponding to the first home appliance 200-1 is selected, the processor 130 may display a UI for controlling the first home appliance 200-1, and if the second item corresponding to the second home appliance 200-2 is selected, the processor 130 may display a UI for controlling the second home appliance 200-2.

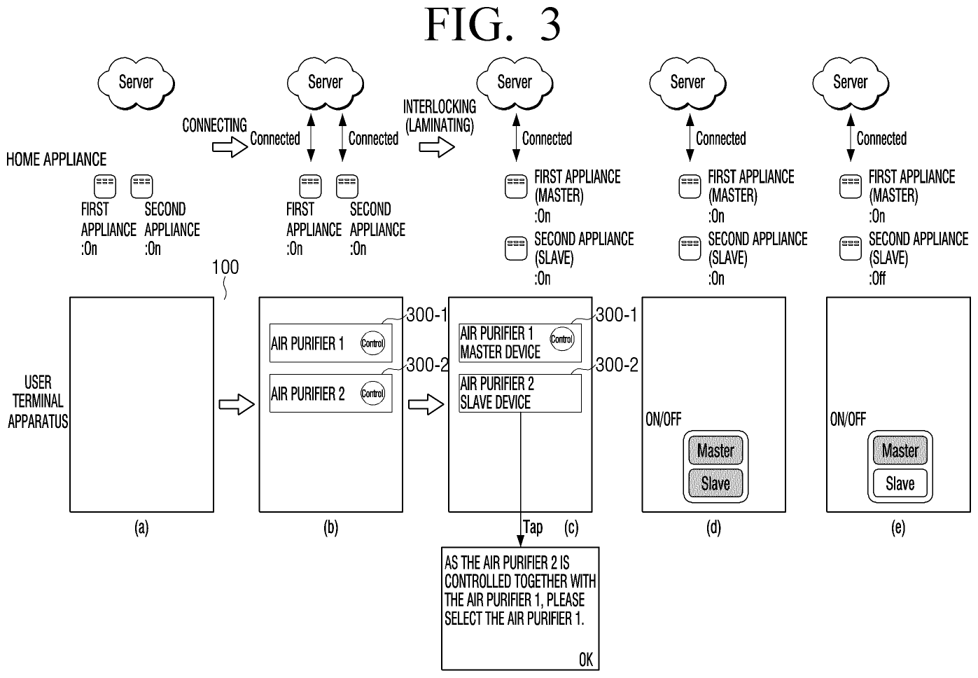

In the items, identification information including type information of each home appliance, etc. may be included. For example, the first item for controlling an air purifier corresponding to the first home appliance 200-1 and the second item for controlling a robot cleaner corresponding to the second home appliance 200-2 may be displayed on the display 120. Also, on the first item, “air purifier” may be displayed, and on the second item, “robot cleaner” may be displayed. Explanation in this regard will be made with reference to FIG. 3.

The processor 130 may receive state information wherein the first home appliance 200-1 is configured as a master device and the second home appliance 200-2 is configured as a slave device through the communicator 110.

Here, the master device is a device that can control the slave device. That is, the user terminal apparatus 100 may control only the master device, and the slave device may be controlled by the master device.

State information is information wherein it is identified which device between the first and second home appliances is the master device and which device is the slave device. State information may be received from at least one of the first and second home appliances 200.

Meanwhile, the first home appliance 200-1 may be configured as the master device based on at least one of the arrangement state of the first and second home appliances 200 and a user instruction. For example, in case a device in the upper part among a plurality of laminated home appliances is configured as the master device, if a plurality of home appliances are laminated, the device located in the upper part may be the first home appliance 200-1 which is the master device. Alternatively, in case the first and second home appliances 200 are interlocked, the first home appliance 200-1 may be the master device by selection of a user. As an example, when the first and second home appliances 200 registered in the user terminal apparatus 100 are interlocked, a UI requesting selection of one of the first and second home appliances 200 as the master device may be provided on the display 120. Afterwards, the device which a user selected as the master device may be the first home appliance 200-1.

When state information wherein the first home appliance 200-1 is configured as the master device and the second home appliance 200-2 is configured as the slave device is received, the processor 130 may change the display state of the second item. Also, if the first item is selected, the processor 130 may provide a UI for integrally controlling the first and second home appliances 200 on the display 120.

When the state information is received, the processor 130 may change the second item into an inactivated state. That is, when the state information is received, the processor 130 may change the display state of the second item into an inactivated state.

As the second item for controlling the slave device is inactivated, it may be indirectly notified to a user that the slave device is integrally controlled by the master device.

Here, the inactivated state may be a state wherein the second item for controlling the slave device went through dim processing or is concealed.

If the second item is selected, the processor 130 may provide information notifying that the second home appliance 200-2 is integrally controlled on a UI for controlling the master device.

That is, in case the inactivated second item is selected as the state information is received, the processor 130 may provide information notifying that the second home appliance 200-2 which is the slave device is controlled on a UI for controlling the master device. For example, in case the inactivated second item for controlling a BBB device which is the slave device is selected, the processor 130 may provide text information like “As the BBB device is controlled together with the AAA device, please select the AAA device” on the display 120. However, such a means for providing information is not limited to texts, but information notifying that the slave device is also controlled on a UI for controlling the master device may be provided by various means such as images, sounds, voices, LED outputs, etc. That is, the processor 130 may directly notify to a user that the slave device is integrally controlled by the master device.

When the state information is received, the processor 130 may provide information indicating whether the first and second home appliances 200 are the master device or the slave device through the display 120 based on the state information.

For example, the processor 130 may display information indicating that the first home appliance 200-1 is the master device on the first item for controlling the first home appliance 200-1, and display information indicating that the second home appliance 200-2 is the slave device on the second item for controlling the second home appliance 200-2 on the display 120. Alternatively, the processor 130 may display the colors of the first item and the second item differently, and thereby indicate that the first home appliance 200-1 is the master device, and the second home appliance 200-2 is the slave device.

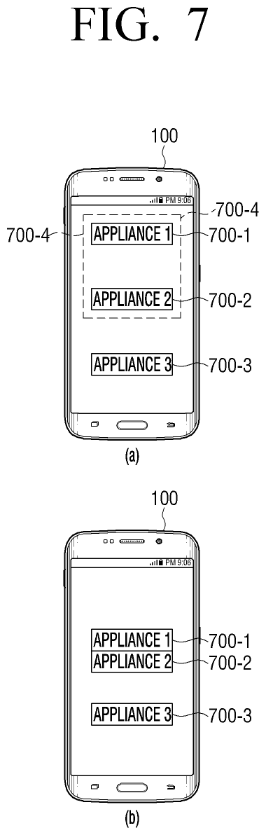

Also, in order to indicate that the first and second home appliances 200 are in an interlocked state, the processor 130 may display the first item for controlling the first home appliance 200-1 and the second item for controlling the second home appliance 200-2 in one diagram together, or arrange them to be relatively adjacent. Alternatively, the processor 130 may display the first and second items with the same color and thereby indicate that they are in an interlocked state. Detailed explanation in this regard will be made with reference to FIG. 7 below.

A UI for integrally controlling the first and second home appliances may include menus for controlling the first home appliance.

A UI for integrally controlling the first and second home appliances 200 is a screen displayed on the display 120 when the first item is selected, and may include menus for manipulating the detailed functions of the first home appliance 200-1. For example, in case the first home appliance 200-1 is an air conditioner, a UI for controlling the air conditioner may include menus for manipulating a power turning-on/turning-off function, a temperature adjusting function, a cooling function, an air blasting function, a dehumidifying function, etc.

According to an embodiment of the disclosure, in case the first and second home appliances 200 are the same type, most functions of the first and second home appliances 200 may be integrally controlled. In case the first and second home appliances 200 are different types, the processor 130 may integrally control functions that are in common between the first and second home appliances 200. The processor 130 may separately display menus on a UI corresponding to the common functions between the first and second home appliances 200.

For example, in case both of the first and second home appliances 200 are air purifiers, most functions of the first and second home appliances 200 may be similar or identical. In this case, power turning-on/turning-off, strength of air purification, a driving mode, sleeping reservation, etc. which are the common functions of the first and second home appliances 200 may be integrally controlled. As an example, in case a user instruction for setting the strength of air purification as “strong” is input on a UI that can integrally control the first and second home appliances 200, the strength of air purification of the first and second home appliances 200 may be integrally controlled as “strong.”

Meanwhile, in case the first home appliance 200-1 is an air purifier, and the second home appliance 200-2 is a robot cleaner, a UI for integrally controlling the first and second home appliances 200 may include power turning-on/turning-off, strength of air purification, a driving mode, a sleeping reservation menu, etc. which are the functions of an air purifier. The processor 130 may separately display menus corresponding to power turning-on/turning-off, sleeping reservation, etc. which are the common functions of the first and second home appliances 200. For example, the processor 130 may enlarge the sizes of the menus corresponding to power turning-on/turning-off, sleeping reservation, etc. displayed on the UI, or display the colors of the menus differently, or make the menus flicker. Accordingly, a user may conveniently recognize functions that are common functions of the first and second home appliances 200 and can be integrally controlled.

Meanwhile, the processor 130 may separately display a UI that can independently control each of the first and second home appliances 200 on a UI for integrally controlling the first and second home appliances 200. Specifically, a UI that can control the second home appliance 200-2 may be separately displayed. Accordingly, even if the first and second home appliances 200 are interlocked with each other, each of the first and second home appliances 200 may be independently controlled.

If a menu included in the UI for integrally controlling the first and second home appliances 200 is selected, the processor 130 may transmit a control command for making a control operation corresponding to the menu performed at both of the first and second home appliances 200 to the first home appliance 200-1.

The processor 130 may transmit a control command to the first home appliance 200-1 based on identification information of the first home appliance 200-1 which is the master device. The first home appliance 200-1 may transmit a control signal corresponding to the input command to the second home appliance 200-2 which is the slave device and perform an operation corresponding to the input command together with the second home appliance 200-2. The second home appliance 200-2 may ignore the control signal transmitted from the user terminal apparatus 100 and perform only an operation corresponding to the control signal received from the first home appliance 200-1.

For example, it is assumed that the first and second home appliances 200 are air purifiers, and the first air purifier is the master device, and the second air purifier is the slave device. If a user instruction changing the strength of air purification of the first and second air purifiers to “strong” is input, the processor 130 may transmit a signal corresponding to the strength of air purification “strong” to the first air purifier based on identification information of the first air purifier. Afterwards, the first air purifier may transmit the signal corresponding to the strength of air purification “strong” to the second air purifier, and the strength of air purification of the first and second air purifiers may be changed to “strong” together.

If the first and second home appliances 200 are home appliances of different types, and a function corresponding to a menu is a common function of the first and second home appliances 200, the processor 130 may transmit a first control code and a second control code respectively corresponding to the types of the first and second home appliances 200 to the first home appliance 200-1.

For example, a case wherein the first home appliance 200-1 which is the master device is an air purifier and the second home appliance 200-2 which is the slave device is a humidifier will be assumed. As the humidifier is the slave device, it does not directly receive a control command from the user terminal apparatus 100, but may receive a control command from the air purifier which is the master device. In case a command to turn off the power after 30 minutes is input into the user terminal apparatus 100 with respect to a sleeping reservation function which is a common function of the air purifier and the humidifier, the processor 130 may transmit a first control code including a command to turn off the power after 30 minutes at the air purifier and a second control code including a command to turn off the power after 30 minutes at the humidifier to the air purifier. Afterwards, the air purifier may transmit the second control code to the humidifier, and the powers of the air purifier and the humidifier may be turned off together after 30 minutes.

If the first and second home appliances 200 are home appliances of different types, and a function corresponding to a menu is not a function provided at the second home appliance 200-2, the processor 130 may transmit a control code controlling to make the second home appliance 200-2 provide a function related to the function corresponding to the menu to the first home appliance 200-1.

For example, a case wherein the first home appliance 200-1 which is the master device is an air purifier and the second home appliance 200-2 which is the slave device is a humidifier will be assumed.

In case a command changing the strength of air purification to “strong” which is a function not provided at the humidifier which is the slave device is input into the user terminal apparatus 100, the processor 130 may transmit a control code changing the humidification strength of the humidifier to “strong” to the air purifier. It is obvious that the processor 130 transmits a control code changing the strength of air purification to “strong” to the air purifier. Afterwards, the air purifier may transmit the control code changing the humidification strength of the humidifier to “strong” to the humidifier, and the air purifier may be operated while the strength of air purification is changed to “strong” and the humidifier may be operated while the strength of humidification is changed to “strong.”

A function of the second home appliance 200-2 which is similar to a function provided at the first home appliance 200-1 may be set in advance or set by a user. If a specific menu performed at the first home appliance 200-1 is selected, a user may set a macro such that a specific function is performed at the second home appliance 200-2. For example, in case the first home appliance 200-1 which is the master device is an air purifier and the second home appliance 200-2 which is the slave device is a robot cleaner, if a command changing the strength of air purification of the air purifier to “strong” is input, sleeping reservation that the power is turned off after 30 minutes may be set as a macro at the robot cleaner. If a user inputs a command changing the strength of air purification to “strong,” the power of the robot cleaner may be turned off after 30 minutes.

According to another embodiment of the disclosure, state information may be received from an external server. That is, the processor 130 may perform communication with the first and second home appliances 200 through an external server. Specifically, the processor 130 may receive identification information of the first and second home appliances 200 from an external server, and if a user instruction for controlling the first and second home appliances 200 is input, the processor 130 may transmit the input instruction to the first home appliance 200-1 which is the master device through the external server.

Here, the external server may be a cloud server storing information on the first and second home appliances 200.

Hereinafter, for the convenience of explanation, it will be described that the user terminal apparatus 100 performs communication with the first and second home appliances 200 through an external server.

FIG. 3 is a diagram for illustrating a UI controlling the first and second home appliances of the same type according to an embodiment of the disclosure.

According to FIG. 3, it will be assumed that the first and second home appliances 200 are implemented as an air purifier 1 (the first device) and an air purifier 2 (the second device).

FIG. 3A is a diagram illustrating a state wherein the air purifier 1 and the air purifier 2 are not registered in the user terminal apparatus 100, and the air purifier 1 and the air purifier 2 are not interlocked with each other. Accordingly, on the display 120 of the user terminal apparatus 100, devices that can be controlled may not be displayed.

FIG. 3B is a diagram illustrating a state wherein each of the air purifier 1 and the air purifier 2 is connected with a server. As each of the air purifier 1 and the air purifier 2 is connected with a server, identification information of the air purifier 1 and the air purifier 2 may be stored in the server. The user terminal apparatus 100 may receive the identification information of the air purifier 1 and the air purifier 2 from the server, and display items for controlling each of the air purifier 1 and the air purifier 2 on the display 120. A first item 300-1 for controlling the air purifier 1 and a second item 300-2 for controlling the air purifier 2 may be displayed on the display 120. The user terminal apparatus 100 may display the mark “control” on each of the first item 300-1 and the second item 300-2 to indicate that the first item 300-1 and the second item 300-2 are in an activated state.

FIG. 3C is a diagram illustrating a state wherein the air purifier 1 and the air purifier 2 are laminated and interlocked with each other. The air purifier 1 may be arranged on the top portion of the air purifier 2 and the air purifier 1 may be the master device. The user terminal apparatus 100 may receive state information including the information that the air purifier 1 is the master device, and the air purifier 2 is the slave device through a server. Afterwards, the user terminal apparatus 100 may change the second item 300-2 for controlling the air purifier 2 into an inactivated state. Here, an inactivated state may be a state wherein the item goes through dim processing or is concealed. That is, the user terminal apparatus 100 may perform dim processing on the second item 300-2, or conceal the second item 300-2 to indicate that the second item 300-2 is in an inactivated state.

In addition to changing the item into an inactivated state, the user terminal apparatus 100 may provide state information by displaying that the air purifier 1 is the master device with a text on the first item 300-1, displaying that the air purifier 2 is the slave device with a text on the second item 300-2, or as illustrated in FIG. 3C, removing the mark “control” displayed on the second item 300-2.

In case the second item 300-2 which is in an inactivated state for controlling the air purifier 2 which is the slave device is selected, the user terminal apparatus 100 may provide information notifying that the slave device is also controlled on a UI for controlling the master device. For example, if the second item 300-2 which is in an inactivated state is selected, the user terminal apparatus 100 may provide text information like “As the air purifier 2 is controlled together with the air purifier 1, please select the air purifier 1” on the display 120. However, such a means for providing information is not limited to texts, but information notifying that the slave device is also controlled on a UI for controlling the master device may be provided by various means such as images, sounds, voices, LED outputs, etc.

FIG. 3D is a diagram for illustrating an operation of displaying a UI for controlling the master device and the slave device in case the first item 300-1 is selected in FIG. 3C.

If the first item 300-1 for controlling the master device is selected, the user terminal apparatus 100 may display a UI that can control the air purifier which is the master device. For example, as illustrated in FIG. 3D, the user terminal apparatus 100 may provide a UI that can integrally control the power turning-on/turning-off of the air purifier 1 and the air purifier 2. Also, the user terminal apparatus 100 may display a UI that can integrally control not only the power turning-on/turning-off function of the air purifier 1 and the air purifier 2 but also the strength of air purification, a driving mode, sleeping reservation, etc. which are the common functions of the air purifier 1 and the air purifier 2.

Meanwhile, although the air purifier 1 and the air purifier 2 are interlocked with each other, the user terminal apparatus 100 may also provide a UI that can independently control the air purifier 1 and the air purifier 2 on a UI screen according to selection of the first item 300-1.

FIG. 3E is a diagram for illustrating a case wherein a command to turn off the power of the slave device is input in FIG. 3D.

If a command to turn off the power of the slave device is input on the power turning-on/turning-off UI screen in FIG. 3D, the user terminal apparatus 100 may transmit a control signal corresponding to power turning-off of the air purifier 2 to the air purifier 1 and the air purifier 1 may transmit the received control command to the air purifier 2. Accordingly, the power of the air purifier 2 may be turned off In this way, the slave device may be independently controlled.

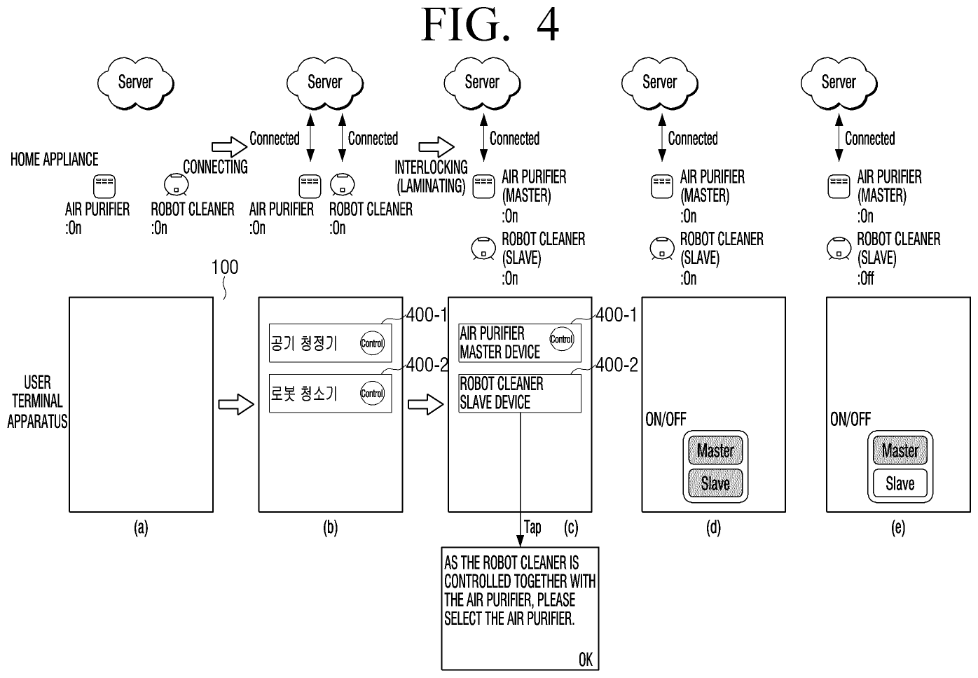

FIG. 4 is a diagram for illustrating a UI controlling the first and second home appliances of different types according to an embodiment of the disclosure.

According to FIG. 4, it will be assumed that the first and second home appliances 200 are implemented as an air purifier and a robot cleaner.

FIG. 4A is a diagram illustrating a state wherein the air purifier and the robot cleaner are not registered in the user terminal apparatus 100, and the air purifier and the robot cleaner are not interlocked with each other. Accordingly, devices that can be controlled may not be displayed on the display 120 of the user terminal apparatus 100.

FIG. 4B is a diagram illustrating a state wherein each of the air purifier and the robot cleaner is connected with a server. As each of the air purifier and the robot cleaner is connected with a server, identification information of the air purifier and the robot cleaner may be stored in the server. The user terminal apparatus 100 may receive the identification information of the air purifier and the robot cleaner from the server, and display items for controlling each of the air purifier and the robot cleaner on the display 120. A first item 400-1 for controlling the air purifier and a second item 400-2 for controlling the robot cleaner may be displayed on the display 120. The user terminal apparatus 100 may display the mark “control” on each of the first item 400-1 and the second item 400-2 to indicate that the first item 400-1 and the second item 400-2 are in an activated state.

FIG. 4C is a diagram illustrating a state wherein the air purifier and the robot cleaner are laminated and interlocked with each other. The air purifier may be arranged on the top portion of the robot cleaner and the air purifier may be the master device. The user terminal apparatus may receive state information including the information that the air purifier is the master device, and the robot cleaner is the slave device through a server. Afterwards, the user terminal apparatus 100 may change the second item 400-2 for controlling the robot cleaner into an inactivated state. Here, an inactivated state may be a state wherein the item goes through dim processing or is concealed. That is, the user terminal apparatus 100 may perform dim processing on the second item 400-2, or conceal the second item 400-2 to indicate that the second item 400-2 is in an inactivated state.

In addition to changing the item into an inactivated state, the user terminal apparatus 100 may provide state information by displaying that the air purifier 1 is the master device with a text on the first item 400-1, displaying that the robot cleaner is the slave device with a text on the second item 400-2, or as illustrated in FIG. 4C, removing the mark “control” displayed on the second item 400-2.

In case the second item 400-2 which is in an inactivated state for controlling the robot cleaner which is the slave device is selected, the user terminal apparatus 100 may provide information notifying that the slave device is also controlled on a UI for controlling the master device. For example, if the second item 400-2 which is in an inactivated state is selected, the user terminal apparatus 100 may provide text information like “As the robot cleaner is controlled together with the air purifier, please select the air purifier” on the display 120. However, such a means for providing information is not limited to texts, but information notifying that the slave device is also controlled on a UI for controlling the master device may be provided by various means such as images, sounds, voices, LED outputs, etc.

FIG. 4D is a diagram for illustrating an operation of displaying a UI for controlling the master device and the slave device in case the first item 400-1 is selected in FIG. 4C.

If the first item 400-1 for controlling the master device is selected, the user terminal apparatus 100 may display a UI that can control the air purifier which is the master device. Alternatively, the user terminal apparatus 100 may display a menu manipulating a function that is in common between the air purifier and the robot cleaner. For example, as illustrated in FIG. 4D, the user terminal apparatus 100 may provide a UI that can integrally control the power turning-on/turning-off of the air purifier and the robot cleaner. Also, the user terminal apparatus 100 may display a UI that can integrally control not only the power turning-on/turning-off function of the air purifier and the robot cleaner but also sleeping reservation, etc. which are the common functions of the air purifier and robot cleaner.

Meanwhile, although the air purifier and the robot cleaner are interlocked with each other, the user terminal apparatus 100 may also provide a UI that can independently control the air purifier and the robot cleaner on a UI screen according to selection of the first item 400-1.

FIG. 4E is a diagram for illustrating a case wherein a command to turn off the power of the slave device is input in FIG. 4D.

If a command to turn off the power of the slave device is input on the power turning-on/turning-off UI screen in FIG. 4D, the user terminal apparatus 100 may transmit a control code corresponding to power turning-off of the robot cleaner to the air purifier and the air purifier may transmit the received control code to the robot cleaner. Accordingly, the power of the robot cleaner may be turned off

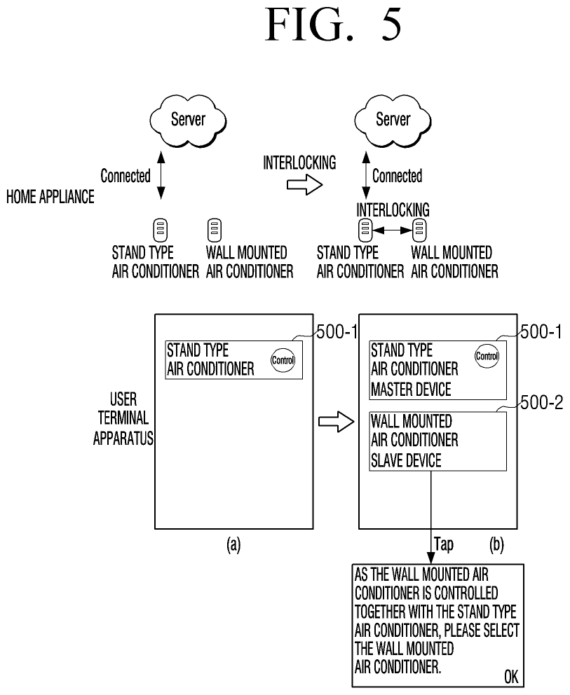

FIG. 5 is a diagram for illustrating a UI controlling the first and second home appliances that are not laminated according to an embodiment of the disclosure.

According to FIG. 5, it will be assumed that the first and second home appliances 200 are implemented as a stand type air conditioner and a wall mounted air conditioner.

FIG. 5A is a diagram illustrating a state wherein only the stand type air conditioner is connected with a server. As the stand type air conditioner is connected with a server, identification information of the stand type air conditioner may be stored in the server. The user terminal apparatus 100 may receive the identification information of the stand type air conditioner from the server, and display a first item 500-1 for controlling the stand type air conditioner on the display 120. The user terminal apparatus 100 may display the mark “control” on the first item 500-1 to indicate that the first item 500-1 is in an activated state.

FIG. 5B is a diagram illustrating a state wherein the stand type air conditioner and the wall mounted air conditioner are interlocked with each other without being laminated. The user terminal apparatus 100 may receive state information including the information that the stand type air conditioner is the master device, and the wall mounted air conditioner is the slave device through a server. Afterwards, the user terminal apparatus 100 may change the second item 500-2 for controlling the wall mounted air conditioner into an inactivated state.

In addition to changing the item into an inactivated state, the user terminal apparatus 100 may display that the stand type air conditioner is the master device with a text on the first item 500-1, display that the wall mounted air conditioner is the slave device with a text on the second item 500-2, or as illustrated in FIG. 5B, display the mark “control” only on the first item 500-1.

In case the second item 500-2 which is in an inactivated state for controlling the wall mounted air conditioner which is the slave device is selected, the user terminal apparatus 100 may provide information notifying that the slave device is also controlled on a UI for controlling the master device. For example, if the second item 500-2 which is in an inactivated state is selected, the user terminal apparatus 100 may provide text information like “As the wall mounted air conditioner is controlled together with the stand type air conditioner, please select the stand type air conditioner” on the display 120. However, such a means for providing information is not limited to texts, but information notifying that the slave device is also controlled on a UI for controlling the master device may be provided by various means such as images, sounds, voices, LED outputs, etc.

As the operations after the above operations are the same as those in FIG. 4D and FIG. 4E, they will be omitted.

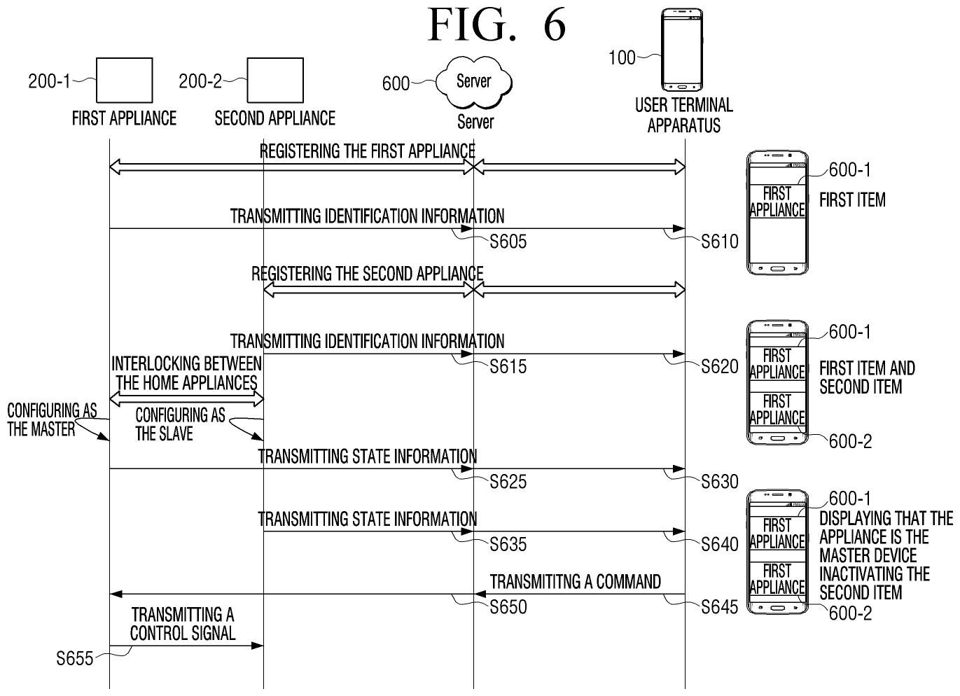

FIG. 6 is a sequence diagram for illustrating operations among a user terminal apparatus, a server, and first and second home appliances according to an embodiment of the disclosure.

The first home appliance 200-1 may transmit the identification information of the first home appliance 200-1 to the server 600 at operation 5605. Here, the identification information may include the IP address, MAC address, product name, and product number, and type information indicating the type of the first home appliance 200-1, etc. When the identification information of the first home appliance 200-1 is received from the server 600 at operation 5610, the user terminal apparatus 100 may register the first home appliance 200-1 in the user terminal apparatus 100. When the first home appliance 200-1 is registered, the user terminal apparatus 100 may provide a first item 600-1 for controlling the first home appliance 200-1 on the display 120.

The second home appliance 200-2 may transmit the identification information of the second home appliance 200-2 to the server 600 at operation 5615. When the identification information of the second home appliance 200-2 is received from the server 600 at operation 5620, the user terminal apparatus 100 may register the second home appliance 200-2 in the user terminal apparatus 100. When the second home appliance 200-2 is registered, the user terminal apparatus 100 may provide a second item 600-2 for controlling the second home appliance 200-2 on the display 120.

In case the first and second home appliances 200-1, 200-2 are interlocked with each other, one of the first and second home appliances 200-1, 200-2 may be the master device, and the other may be the slave device based on at least one of the arrangement state of the first and second home appliances 200-1, 200-2 and selection of a user.

The first home appliance 200-1 may transmit state information that the first home appliance 200-1 is the master device to the server 600 at operation 5625. When state information that the first home appliance 200-1 is the master device is received from the server at operation 5630, the user terminal apparatus 100 may display information indicating that the first home appliance 200-1 is the master device on the first item 600-1.

The second home appliance 200-2 may transmit state information that the second home appliance 200-2 is the slave device to the server 600 at operation 5635. When state information that the second home appliance 200-2 is the slave device is received from the server at operation 5640, the user terminal apparatus 100 may change the second item 600-2 into an inactivated state.

If a command controlling the first and second home appliances 200-1, 200-2 are input into the user terminal apparatus 100, the user terminal apparatus 100 may transmit the command to the first home appliance 200-1 which is the master device through the server 600 at operations 5645 and 5650. The first home appliance 200-1 may transmit a signal corresponding to the command to the second home appliance 200-2 which is the slave device at operation 5655, and the first and second home appliances 200-1, 200-2 may be integrally controlled.

As the detailed operations in each step were described above, detailed explanation will be omitted.

FIG. 7 is a diagram for illustrating an operation of indicating that the first and second home appliances are in an interlocked state on a display according to an embodiment of the disclosure.

It is assumed that the device 1, the device 2, and the device 3 are registered in the user terminal apparatus 100, and the first item 700-1, the second item 700-2, and the third item 700-3 for controlling the device 1, the device 2, and the device 3 are displayed on the display 120, and afterwards, the device 1 and the device 2 are in an interlocked state.

According to FIG. 7A, the user terminal apparatus 100 may display the first item 700-1 for controlling the device 1 and the second item 700-2 for controlling the device 2 together in one diagram for indicating that the device 1 and the device 2 are in an interlocked state. As illustrated in FIG. 7A, the user terminal apparatus 100 may display the first item 700-1 and the second item 700-2 inside dotted lines in the form of a square. Here, it is obvious that the square and the dotted lines may be displayed while being changed into various forms.

According to FIG. 7B, in order to indicate that the device 1 and the device 2 are in an interlocked state, the user terminal apparatus 100 may arrange the first item 700-1 for controlling the device 1 and the second item 700-2 for controlling the device 2 to be relatively adjacent. As illustrated in FIG. 7B, the user terminal apparatus 100 may arrange the items such that the distance between the first item 700-1 and the second item 700-2 is more adjacent than the distance between the second item 700-2 and the third item 700-3.

According to another embodiment of the disclosure, the user terminal apparatus 100 may display the first item and the second item in the same color and thereby indicate that the items are in an interlocked state.

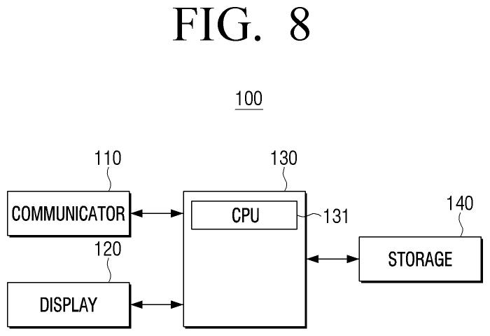

FIG. 8 is a diagram illustrating an example of a detailed configuration of the user terminal apparatus in FIG. 2.

According to FIG. 8, the user terminal apparatus 100 includes a communicator 110, a display 120, a processor 130, and a storage 140. Among the components illustrated in FIG. 8, regarding components that overlap with the components illustrated in FIG. 2, detailed explanation will be omitted.

The processor 130 may include a CPU 121, a ROM (or a non-volatile memory) storing a control program for controlling the user terminal apparatus 100, and a RAM (or a volatile memory) storing data input from the outside of the user terminal apparatus 100 or used as a storage area corresponding to various jobs performed at the user terminal apparatus 100.

When a predetermined event occurs, the processor 130 may execute the operating system (OS), programs, and various applications stored in the storage part 140. The processor 130 may include a single core, a dual core, a triple core, a quad core, and cores of multiple times thereof

The CPU 131 accesses the storage 140, and performs booting by using the 0/S stored in the storage 140. Then, the CPU 131 performs various operations by using various kinds of programs, contents, data, etc. stored in the storage 140.

The storage 140 may store various kinds of data, programs, or applications for operating/controlling the user terminal apparatus 100. The storage 140 may store control programs for controlling the user terminal apparatus 100 and the processor 130, applications initially provided from the manufacturer or downloaded from the outside, databases, or related data. For example, the storage 140 may provide a UI for setting multi-channels according to the various embodiments of the disclosure, and store programs for performing operations related to the UI.

In particular, the storage 140 may store identification information of the first and second home appliances received from the first and second home appliances or an external server. Here, the identification information may include the IP addresses, MAC addresses, product names, and product numbers of the first and second home appliances 200, and type information indicating the types of the first and second home appliances 200, etc. Also, the storage part 140 may store state information indicating the information wherein one of the first and second home appliances 200 is configured as the master device and the other is configured as the slave device from the first and second home appliances or an external server.

The storage 140 may be implemented as an internal memory such as a ROM, a RAM, etc. included in the processor 130, or implemented as a separate memory from the processor 130. In this case, the storage 140 may be implemented in the form of a memory embedded in the user terminal apparatus 100, or in the form of a memory that can be attached on or detached from the user terminal apparatus 100, according to the usage of stored data. For example, in the case of data for operating the user terminal apparatus 100, the data may be stored in a memory embedded in the user terminal apparatus 100, and in the case of data for an extended function of the user terminal apparatus 100, the data may be stored in a memory that can be attached on or detached from the user terminal apparatus 100. Meanwhile, in the case of a memory embedded in the user terminal apparatus 100, the memory may be implemented in forms such as a non-volatile memory, a volatile memory, a hard disc drive (HDD), or a solid state drive (SSD), etc.

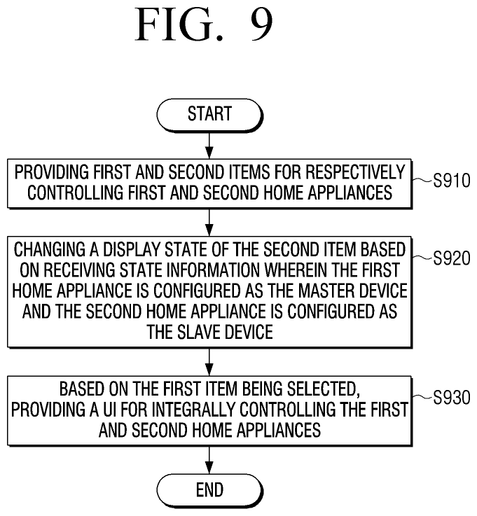

FIG. 9 is a flow chart for illustrating a control method of a user terminal apparatus according to an embodiment of the disclosure.

According to FIG. 9, the user terminal apparatus may provide first and second items for respectively controlling the first and second home appliances at operation S910.

If state information wherein the first home appliance 200-1 is configured as the master device and the second home appliance 200-2 is configured as the slave device is received, the user terminal apparatus may change the display state of the second item at operation S920. Here, change of the display state may include changing the second item into an inactivated state when state information is received. State information may be received from at least one of the first and second home appliances, or received from a server.

Meanwhile, the first home appliance 200-1 may be configured as the master device based on at least one of the arrangement state of the first and second home appliances 200 or a user instruction.

If the first item is selected, the user terminal apparatus may provide a UI for integrally controlling the first and second home appliances 200 at operation 5930. Here, a UI for integrally controlling the first and second home appliances 200 may include a menu for controlling the first home appliance 200-1. When a menu is selected, the user terminal apparatus may transmit a control command making a control operation corresponding to the menu performed at both of the first and second home appliances 200 to the first home appliance 200-1.

If the first and second home appliances 200 are home appliances of different types, and a function corresponding to a menu is a common function of the first and second home appliances 200, the user terminal apparatus may transmit a first control code and a second control code respectively corresponding to the types of the first and second home appliances 200 to the first home appliance 200-1.

If the first and second home appliances 200 are home appliances of different types, and a function corresponding to a menu is not a function provided at the second home appliance 200-2, the user terminal apparatus may transmit a control code controlling to make the second home appliance 200-2 provide a function related to the function corresponding to the menu to the first home appliance 200-1.

If the second item is selected, the user terminal apparatus may provide information notifying that the second home appliance 200-2 is integrally controlled on a UI for controlling the master device.

When state information is received, the user terminal apparatus may provide information indicating whether the first and second home appliances 200 are the master device or the slave device based on the state information.

As the detailed operations in each step were described above, detailed explanation will be omitted.

Meanwhile, at least some of the methods according to the aforementioned various embodiments of the disclosure may be implemented in the form of an application that can be installed on conventional electronic apparatuses.

Also, at least some of the methods according to the aforementioned various embodiments of the disclosure may be implemented just by software upgrade, or hardware upgrade of conventional electronic apparatuses.

0503-0468 (DM-201712-002-1-USO, OEC/11638/US)

English Translation

In addition, at least some of the aforementioned various embodiments of the disclosure may be performed through an embedded server provided on an electronic apparatus, or an external server of an electronic apparatus.

Meanwhile, the aforementioned various embodiments of the disclosure may be implemented in a recording medium that is readable by a computer or a device similar thereto, by using software, hardware or a combination thereof In some cases, the embodiments described in this specification may be implemented as a processor itself According to implementation by software, the embodiments such as procedures and functions described in this specification may be implemented as separate software modules. Each of the software modules may perform one or more functions and operations described in this specification.

Meanwhile, computer instructions for executing the processing operations according to the various embodiments of the disclosure described above may be stored in a non-transitory computer readable medium. Such computer instructions stored in a non-transitory computer readable medium may make the processing operations according to the various embodiments described above performed by a specific machine, when they are executed by a processor.

A non-transitory computer-readable medium refers to a medium that stores data semi-permanently, and is readable by machines, but not a medium that stores data for a short moment such as a register, a cache, and a memory. As specific examples of a non-transitory computer-readable medium, there may be a CD, a DVD, a hard disc, a blue-ray disc, a USB, a memory card, a ROM and the like.

While preferred embodiments of the disclosure have been shown and described, the disclosure is not limited to the aforementioned specific embodiments, and it is apparent that various modifications can be made by those having ordinary skill in the art to which the disclosure belongs, without departing from the gist of the disclosure as claimed by the appended claims. Also, it is intended that such modifications are not to be interpreted independently from the technical idea or prospect of the disclosure.

What is claimed is:

1. A user terminal apparatus in which a first home appliance and a second home appliance are registered comprising:
a communicator;
a display; and
and a processor configured to:
provide a first item and a second item for controlling the first home appliance and the second home appliance respectively on the display, and change a display state of the second item based on state information in which the first home appliance is configured as a master device and the second home appliance is configured as a slave device being received through the communicator, provide a UI for integrally controlling the first home appliance and the second home appliance on the display based on the first item being selected.

2. The user terminal apparatus of claim 1, wherein the processor is configured to:
based on receiving the state information, change the second item into an inactivated state.

3. The user terminal apparatus of claim 1, wherein a UI for integrally controlling the first and second home appliances includes a menu for controlling the first home appliance, and the processor is configured to:
based on the menu being selected, transmit a control command for making a control operation corresponding to the menu performed at both of the first and second home appliances to the first home appliance.

4. The user terminal apparatus of claim 3, wherein the processor is configured to:
based on the first and second home appliances being home appliances of 0503-0468 (DM-201712-002-1-USO, OEC/11638/US) English Translation different types, and a function corresponding to the menu being a common function of the first and second home appliances, transmit a first control code and a second control code respectively corresponding to the types of the first and second home appliances to the first home appliance.

5. The user terminal apparatus of claim 3, wherein the processor is configured to:
based on the first and second home appliances being home appliances of different types, and a function corresponding to the menu not being a function provided at the second home appliance, transmit a control code for controlling such that the second home appliance provides a function related to the function corresponding to the menu to the first home appliance.

6. The user terminal apparatus of claim 1, wherein the state information is received from at least one of the first or second home appliances, or received from an external server.

7. The user terminal apparatus of claim 1, wherein the first home appliance is configured as a master device based on at least one of an arrangement state of the first and second home appliances or a user instruction.

8. The user terminal apparatus of claim 1, wherein the processor is configured to:
based on the second item being selected, provide information notifying that the second home appliance is integrally controlled on a UI for controlling the master device.

9. The user terminal apparatus of claim 1, wherein the processor is configured to:
based on receiving the state information, provide information indicating whether 0503-0468 (DM-201712-002-1-USO, OEC/11638/US) English Translation the first and second home appliances are a master device or a slave device through the display.

10. A system comprising a first home appliance and a second home appliance and a user terminal apparatus capable of integrally controlling the home appliances, the system comprising:
a first home appliance and a second home appliance transmitting state information in which the first home appliance is configured as a master device and the second home appliance is configured as a slave device to the user terminal apparatus;
and a user terminal apparatus configured to:
provide a first item and a second item for controlling the first home appliance and the second home appliance respectively, and change a display state of the second item based on receiving the state information, and provide a UI for integrally controlling the first home appliance and the second home appliance based on the second item being selected.

11. A control method of a user terminal apparatus in which a first home appliance and a second home appliance are registered, the method comprising:
providing a first item and a second item for controlling the first home appliance and the second home appliance respectively;
changing a display state of the second item based on state information in which the first home appliance is configured as a master device and the second home appliance is configured as a slave device being received; and
providing a UI for integrally controlling the first home appliance and the second home appliance based on the first item being selected.

12. The control method of claim 11, wherein the changing a display state comprises:
based on receiving the state information, changing the second item into an 0503-0468 (DM-201712-002-1-USO, OEC/11638/US) English Translation inactivated state.

13. The control method of claim 11, wherein a UI for integrally controlling the first and second home appliances includes a menu for controlling the first home appliance, and the control method further comprising:
based on the menu being selected, transmitting a control command for making a control operation corresponding to the menu performed at both of the first and second home appliances to the first home appliance.

14. The control method of claim 13, wherein the transmitting comprises:
based on the first and second home appliances being home appliances of different types, and a function corresponding to the menu being a common function of the first and second home appliances, transmitting a first control code and a second control code respectively corresponding to the types of the first and second home appliances to the first home appliance.

15. The control method of claim 13, wherein the transmitting comprises:
based on the first and second home appliances being home appliances of different types, and a function corresponding to the menu not being a function provided at the second home appliance, transmitting a control code for controlling such that the second home appliance provides a function related to the function corresponding to the menu to the first home appliance.
